(19) United States
(12) Patent Application Publication
(10) Pub. No.: US 2004/0085314 A1
(43) Pub. Date: May 6, 2004

(54) Method for rendering outlines of 3D objects

(76) Inventors: Yu-Ru Lin, Taoyuan (TW); Alpha Wu, Taipei (TW)

Correspondence Address: BIRCH STEWART KOLASCH & BIRCH, PO BOX 747, FALLS CHURCH, VA, 22040-0747, US

(21) Appl. No.: 10/287,600

(22) Filed: Nov. 5, 2002

(51) Int. Cl. G06T 17/00

(52) U.S. Cl. 345/428

(57) ABSTRACT

A method for rendering outlines of a 3D object. The object is modeled by polygons. The method comprises steps of identifying front- and back-facing polygons, storing edges of the back-facing polygons into a SE buffer when the edge to be stored is different from those previously stored in the SE buffer, otherwise, erasing from the SE buffer the matching edge, storing the edges of the front-facing polygons into a CE buffer when the edge to be stored is different from those previously stored in CE buffer, otherwise, erasing from the CE buffer the matching edge when an included angle between normals of their polygons is smaller than a threshold, constructing mesh on the edges stored in the two buffers, and rendering the outlines of the object by the mesh.

### BACKGROUND OF THE INVENTION

1. Field of the Invention

The present invention relates to image rendering and particularly to a simple and efficient object-based method for rendering stylized outlines of 3D polygon mesh to depict the shape of an object, important in application ranging from visualization to non-photorealistic rendering (NPR).

2. Description of the Prior Art

Non-photorealistic rendering (NPR) has become an important research area in computer graphics. One interesting fact in this area is that many of the techniques developed over the years in computer graphics research can be used here to create specific effects. This covers image processing filters as well as silhouette computation or special rendering algorithms. Indeed, many NPR images are created by starting from a 3D model and combining many different algorithms to yield exactly the image the user wants. Due to the number of algorithms available, there are possibly many combinations that can produce an image. The approach which has to be taken to create a non-photorealistic rendition differs from photorealistic image generation—there is simply no rendering equation to be solved in order to derive a pixel's color.

Object outline extraction is an important process for NPR. While there are many types of outline, the Art here focuses on silhouettes, surface boundaries and creases. Research in extracting outlines can be divided into two classes: object-based and image-based. Image-based algorithms traditionally render images in special way and then apply image-processing filters. These approaches are easier to implement, but multi-pass filtering creates a heavy burden on real-time applications. To detect outlines in object space, the silhouettes, surface boundaries, and creases must be explicitly found or computed. Usually object-based algorithms require adjacent information of object surfaces to determine the crease or surface boundaries. Creating the information is time-consuming however, and not suitable for dynamic mesh.

Image-based outline rendering methods usually have distinguished results in stylization, for example, to simulate painted images, but often take from a few seconds to several minutes to render a frame, due to inheriting performance from image-based outline extraction algorithms, and further, the results can rarely achieve frame-to-frame coherence.

Object-based outline rendering methods, however, are sparse. Most research focuses on rendering silhouettes. A creative method of creating mesh on silhouettes is proposed, but the mesh is flat and provides a less-than optimal view when parallel, or nearly parallel, to the flat surface, such that the silhouettes disappear.

### SUMMARY OF THE INVENTION

The object of the present invention is to provide a simple and efficient object-based method for rendering stylized outlines of three-dimensional polygon mesh. The preprocessing or adjacent information, such as the connectivity between surfaces, is not necessary the inventive outline extraction process extracts complete outlines including silhouettes, surface boundaries, as well as creases. The succeeding rendering process generates mesh applicable for stylization by applying every kind of stroke texture, and can render stylized outlines with frame-to-frame coherence at interactive rates.

The present invention provides a method for rendering outlines of an object, wherein the object is modeled by polygons. The method comprises steps of identifying the polygons with an acute and obtuse angle between normals of the polygons and viewing vectors as front- and back-facing polygons respectively, storing one edge of the back-facing polygons into a first region, selecting another edge of the back-facing polygons, and storing the selected edge into the first region when the selected edge is different from those previously stored in the first region, otherwise, erasing from the first region the matching edge, until all the edges of the back-facing polygons are selected, storing one edge of the front-facing polygons into a second region, selecting another edge of the front-facing polygons, and storing the selected edge into the second region when the selected edge is different from those previously stored in the second region, otherwise, erasing from the second region the matching edge when an included angle between the normals of the two polygons thereof is smaller than a threshold, until all the edges of the front-facing polygons are selected, constructing mesh on the edges stored in the first and second region, and rendering the outlines of the object by the mesh.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a flowchart of a method for rendering outlines of a 3D object according to one embodiment of the invention.

FIG. 2 is a diagram showing a 3D object for illustration of the method shown in the flowchart of FIG. 1.

FIG. 3 is a diagram showing vertex-mesh according to one embodiment of the invention.

### DETAILED DESCRIPTION OF THE INVENTION

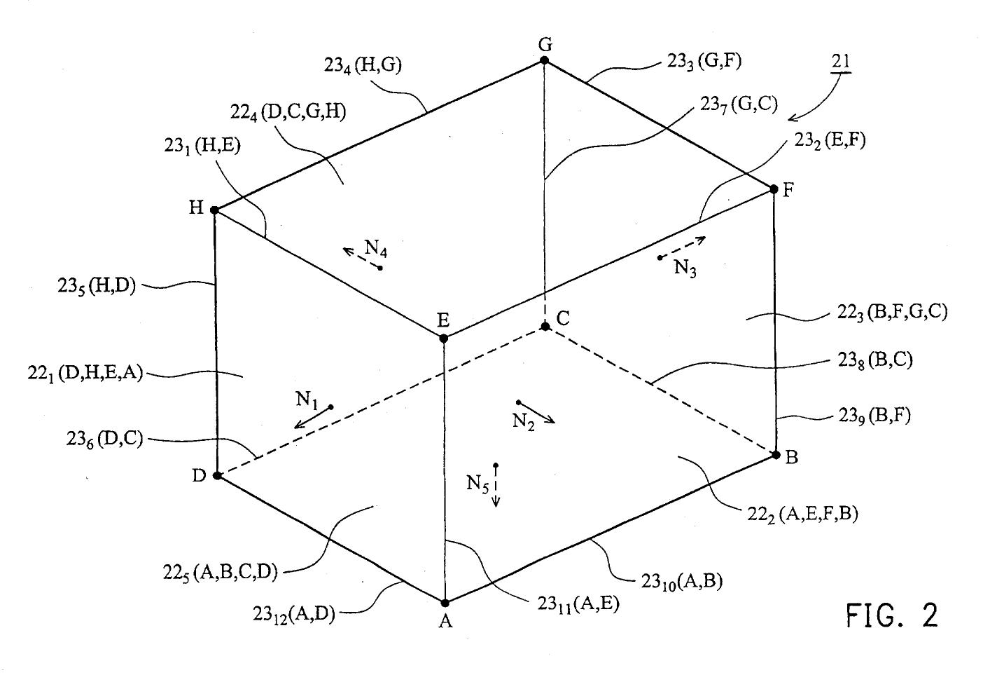

In the following embodiment, a 3D object is modeled by polygons, and the polygons and edges thereof are represented by indices of vertices of the polygons, as shown in FIG. 2 for example. The 3D object 21 has five rectangular polygons 22₁˜22₅. It should be noted that, for the sake of illustration, the top polygon of the 3D object 21 is missing and the rectangular polygons are used here although triangular polygons are typically used. Each of the polygons 22₁˜22₅ and the edges 23₁˜23₁₂ thereof is represented by four and two of the indices A-H of the vertices 24₁˜24₈ respectively. Each of the edges 23₁˜23₁₂ belongs to at most two of the polygons 22₁˜22₅, that is to say, no edge has more than two adjacent polygons.

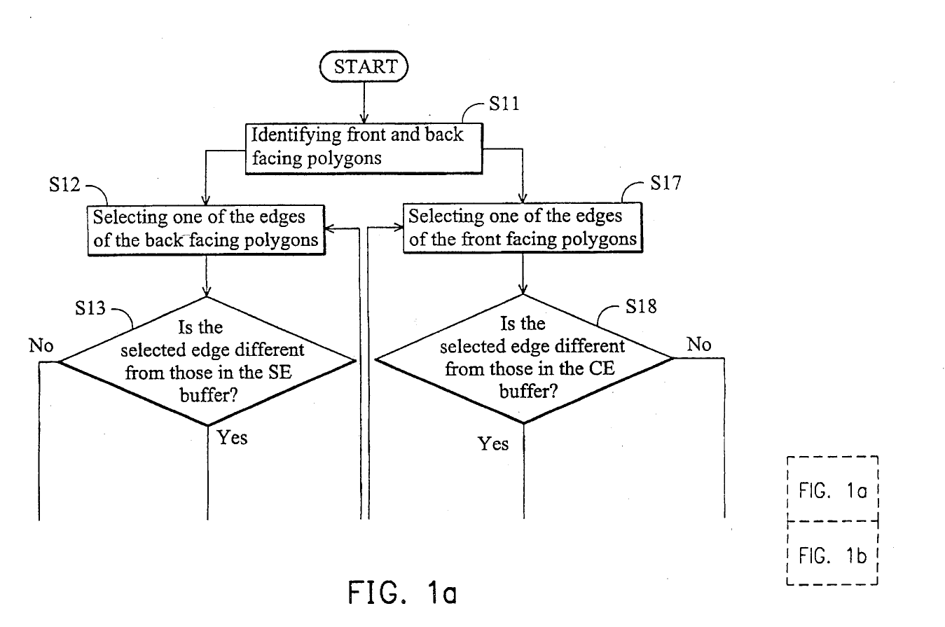

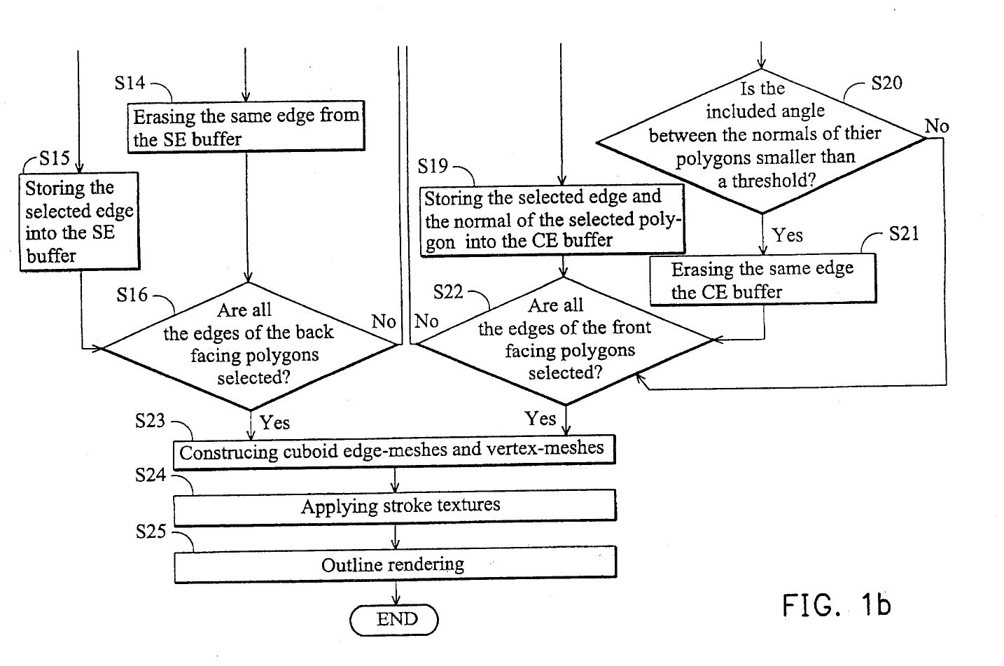

FIG. 1 is a flowchart of a method for rendering outlines of the 3D object 21 shown in FIG. 2 according to the embodiment of the invention. It is noted that a viewing vector is defined as a vector oriented from the central point of the selected polygon to a viewer's position.

In step S11, the polygons with an acute and obtuse angle between normals of the polygons and viewing vectors thereof are identified as front- and back-facing polygons respectively. As shown in FIG. 2, both of the included angles between the normal vectors N₁ and N₂ of the polygons 22₁ and 22₂, and the viewing vectors (not properly shown in FIG. 2) are smaller than 90°, namely, they are acute angles. On the contrary, all the included angles between the normal vectors N₃, N₄ and N₅ of the polygons 22₃˜22₅, and the viewing vectors are larger than 90°, namely, they are obtuse angles. Consequently, the polygons 22₁ and 22₂ are identified as the front-facing polygons, and the polygons 22₃˜22₅ the back-facing polygons.

In step S12, one edge of the back-facing polygons is selected to be stored into a first region such as an SE buffer and compared to the edge(s) in the SE buffer.

In step S13, it is determined whether the selected edge is different from those previously stored in the SE buffer. If so, step S14 is implemented, wherein the selected edge is stored into the SE buffer. Otherwise, step S15 is implemented, wherein the matching edge is erased. Necessarily, in step S12, the first selected edge of the back-facing polygons along with the normal of the selected polygons are stored into the SE buffer since there is not any edge in the SE buffer yet. Afterwards, the number of the edges in the SE buffer will increase as the edges of the back-facing polygons are sequentially selected and compared. In FIG. 2, for example, the edge 23₄ of the back-facing polygon 22₄ is first selected and of course stored into the SE buffer, and then followed by the edges 23₅, 23₆ and 23₇. When the edge 23₆ of the back-facing polygon 22₅ is selected to be stored into the SE buffer and compared to the edges 23₄, 23₅, 23₆ and 23₇, it is found that the same edge 23₆ already exists in the SE buffer, which causes the edge 23₆ to be erased from the SE buffer.

In step S16, it is determined whether all the edges of the back-facing polygons are selected. If they are not, the procedure goes back to step S12. Otherwise, step S23 is implemented. That is to say, a loop formed of steps S12, S13, S14 and S15 is repeated until all the edges of the back-facing polygons are selected and compared. As a result, for the 3D object 21 shown in FIG. 2, the edges belonging to only one back-facing polygon is left in the SE buffer, the edges 23₃, 23₄, 23₅, 23₉, 23₁₀ and 23₁₂. It is noted that all silhouettes 23₅, 23₉, 23₁₀ and 23₁₂, and two surface boundaries 23₃ and 23₄ of the 3D object 21 are found.

In step S17, one edge of the front-facing polygons is selected to be stored into a second region such as a CE buffer and compared to the edge(s) in the CE buffer.

In step S18, it is determined whether the selected edge is different from those previously stored in the CE buffer. If so, step S19 is implemented, wherein the selected edge is stored into the CE buffer. Otherwise, step S20 is implemented, wherein it is further determined whether an included angle between the normals of the two polygons thereof is smaller than a threshold. If so, the matching edge is erased in step S21. Necessarily, the first selected edge of the front-facing polygons is stored into the CE buffer since there is not yet any stored edge. Afterwards, the number of the edges in the CE buffer will increase as the edges of the front-facing polygons are sequentially selected and compared. In FIG. 2, for example, the edge 231 of the front-facing polygon 22, is first selected and stored into the CE buffer, and then followed by the edges 23₅, 23₁₁ and 23₁₂. When the edge 23₁₁ of the front-facing polygon 22₂ is selected to be stored into the CE buffer and compared to the edges 23₁, 23₅, 23₁₁ and 23₁₂, it is found that the same edge 23₁, already exists in the CE buffer. Since the included angle between the normal vectors N₁ and N₂ of the two adjacent front-facing polygons 22₁ and 22₂ of the edge 23₁₁ is 90°, larger than or equal to a threshold 90° for example, the edge 23₁₁ is identified as a crease edge and is not erased from the CE buffer.

In step S22, it is determined whether all the edges of the front-facing polygons are selected. If they are not, the procedure goes back to step S17. Otherwise, step S23 is implemented. That is to say, a loop formed by steps S17, S18, S19, S20 and S21 is repeated until all the edges of the front-facing polygons are selected and compared. As a result, for the 3D object 21 shown in FIG. 2, the edges belonging to only one front-facing polygons or the creases are left in the CE buffer, the edges 23₁, 23₂, 23₅, 23₉, 23₁₀, 23₁₁ and 23₁₂.

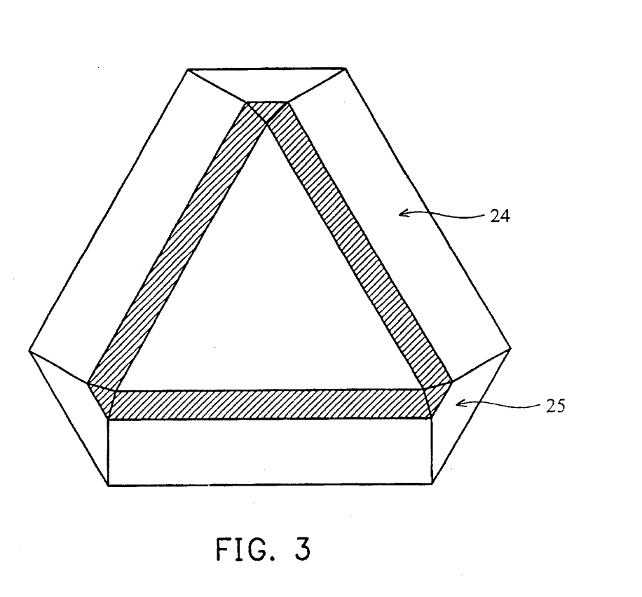

In step s23, 3D mesh, such as cuboid mesh, cylindrical mesh, or other tube-like mesh, is constructed on the edges found in the SE and CE buffer. For the 3D object shown in FIG. 2, the cuboid mesh is constructed on the edges 23₁, 23₂, 23₃, 23₄, 23₅, 23₉, 23₁₀, 23₁₁ and 23₁₂. The edge-mesh 24 is also patched on joints, the vertices A, B, D, E, F, G and H, with vertex-mesh 25 for a smooth transition from mesh to mesh, as shown in FIG. 3.

In step S24, stroke textures are applied on the cuboid mesh.

In step S25, the outlines of the 3D object are rendered by the mesh.

In conclusion, the present invention provides a simple and efficient object-based method for rendering stylized outlines of three-dimensional polygon mesh. Preprocessing or adjacent information, such as the connectivity between surfaces, is not necessary. The inventive outline extraction process can extract complete outlines including silhouettes, surface boundaries, as well as creases. The succeeding rendering process generates mesh applicable to stylization by applying every kind of stroke texture, and renders stylized outlines with frame-to-frame coherence at interactive rates.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for rendering outlines of a 3D object, wherein the object is modeled by polygons, the method comprising steps of:
identifying the polygons with an acute and obtuse angle between normals of the polygons and viewing vectors as front- and back-facing polygons respectively;
storing one edge of the back-facing polygons into a first region;
selecting another edge of the back-facing polygons, and storing the selected edge into the first region when the selected edge is different from those previously stored in the first region, otherwise, erasing from the first region the matching edge, until all the edges of the back-facing polygons are selected;
storing one edge of the front-facing polygons into a second region;
selecting another edge of the front-facing polygons, and storing the selected edge into the second region when the selected edge is different from those previously stored in the second region, otherwise, erasing from the second region the matching edge when an included angle between the normals of the two polygons thereof is smaller than a threshold, until all the edges of the front-facing polygons are selected;
constructing mesh on the edges stored in the first and second region; and
rendering the outlines of the object by the mesh.

2. The method as claimed in claim 1, wherein the mesh is 3D mesh.

3. The method as claimed in claim 2, wherein the mesh is cuboid.

4. The method as claimed in claim 2, wherein the mesh is cylindrical.

5. The method as claimed in claim 2, wherein the mesh is tube-like.

6. The method as claimed in claim 2 further comprising patching the mesh on joints thereof with vertex-mesh.

7. The method as claimed in claim 1 further comprising applying stroke textures on the mesh.

8. The method as claimed in claim 1, wherein the polygons and the edges thereof are represented by indices of vertices of the polygons.

9. The method as claimed in claim 1, wherein each of the edges belongs to at most two of the polygons.

10. The method as claimed in claim 1, wherein the first and second region are buffers.
